(19) United States
(12) Patent Application Publication
(10) Pub. No.: US 2021/0083617 A1
(43) Pub. Date: Mar. 18, 2021

(54) GIMBAL AND MOTOR CONTROL METHOD AND DEVICE

(71) Applicant: SZ DJI TECHNOLOGY CO., LTD., Shenzhen (CN)

(72) Inventors: Wenlin XIE, Shenzhen (CN); Yi JIANG, Shenzhen (CN); Zihan CHEN, Shenzhen (CN)

(21) Appl. No.: 17/103,775

(22) Filed: Nov. 24, 2020

Related U.S. Application Data
(63) Continuation of application No. PCT/CN2018/088897, filed on May 29, 2018.

(51) Int. Cl. H02P 29/64

(52) U.S. Cl. CPC H02P 29/64

(57) ABSTRACT

A motor control method includes obtaining a torque of a motor according to a drive signal used to drive the motor to rotate, determining a temperature of the motor according to the torque and a lasting time of the torque, and when determining that the temperature is higher than a temperature threshold, adjusting a magnitude of the drive signal to reduce the torque.

### CROSS-REFERENCE TO RELATED APPLICATION

This application is a continuation of International Application No. PCT/CN2018/088897, filed May 29, 2018, the entire content of which is incorporated herein by reference.

### TECHNICAL FIELD

The present disclosure generally relates to the motor control field and, more particularly, to a gimbal and motor control method and device.

### BACKGROUND

Currently, overheating protection of a motor (e.g., gimbal motor) usually uses a temperature sensor (e.g., thermocouple) manner. Specifically, the motor temperature is detected by the temperature sensor of the motor. Then, the motor is protected according to the motor temperature detected by the temperature sensor. In this solution, the motor temperature needs to be measured by the temperature sensor, and the cost is high. If the temperature sensor is aged or failed, the motor temperature cannot be measured accurately, which may cause the motor to be burned out.

### SUMMARY

Embodiments of the present disclosure provide a motor control method. The method includes obtaining a torque of a motor according to a drive signal used to drive the motor to rotate, determining a temperature of the motor according to the torque and a lasting time of the torque, and when determining that the temperature is higher than a temperature threshold, adjusting a magnitude of the drive signal to reduce the torque.

Embodiments of the present disclosure provide a motor control device including an electronic speed control (ESC) and one or more controllers. The ESC is connected to a motor. The one or more controllers are connected to the ESC and operate individually or collectively. The one or more controllers are configured to obtain a torque of the motor according to a drive signal used to drive the motor to rotate, determine a temperature of the motor according to the torque and a lasting time of the torque, and when determining that the temperature is higher than a temperature threshold, adjust a magnitude of the drive signal to reduce the torque.

Embodiments of the present disclosure provide a gimbal control method. The method includes, while a gimbal is operating, obtaining a torque of a motor of the gimbal according to a drive signal used to drive the motor to rotate, determining a temperature of the motor according to the torque and a lasting time of the torque, and when determining that the temperature is higher than a temperature threshold, adjusting a magnitude of the drive signal to reduce the torque.

### BRIEF DESCRIPTION OF THE DRAWINGS

FIG. 1 is a schematic diagram showing a working principle of a three-axis gimbal according to some embodiments of the present disclosure.

FIG. 2 is a schematic flowchart of a motor control method according to some embodiments of the present disclosure.

FIG. 3 is a schematic diagram showing a working principle of a gimbal control system according to some embodiments of the present disclosure.

FIG. 4 is a schematic diagram showing a relationship between lasting time of motor torque and motor temperature in a normal operation state according to some embodiments of the present disclosure.

FIG. 5 is a schematic diagram showing a motor torque change when the motor is in a balanced state according to some embodiments of the present disclosure.

FIG. 6 is a schematic diagram of a first prediction model of a motor according to some embodiments of the present disclosure.

FIG. 7 is a schematic diagram of a second prediction model of a motor according to some embodiments of the present disclosure.

FIG. 8 is a schematic diagram of a prediction model of a motor according to some embodiments of the present disclosure.

FIG. 9 is a schematic structural diagram of a motor control device according to some embodiments of the present disclosure.

FIG. 10 is a schematic flowchart of a gimbal control method according to some embodiments of the present disclosure.

FIG. 11 is a schematic structural diagram of a gimbal control device according to some embodiments of the present disclosure.

### DETAILED DESCRIPTION OF THE EMBODIMENTS

The technical solution of embodiments of the present disclosure is described in detail in connection with the accompanying drawings of embodiments of the present disclosure. Described embodiments are merely some embodiments of the present disclosure, not all embodiments. Based on embodiments of the present disclosure, other embodiments obtained by those skilled in the art without creative efforts are within the scope of the present disclosure.

A gimbal and motor control method and device of the present disclosure are described in detail below in connection with the accompanying drawings. When no conflict, features of embodiments of the present disclosure may be combined.

A motor consistent with embodiments of the present disclosure may be applied to a gimbal or other devices or systems. In embodiments of the present disclosure, an example of applying the motor to the gimbal is described.

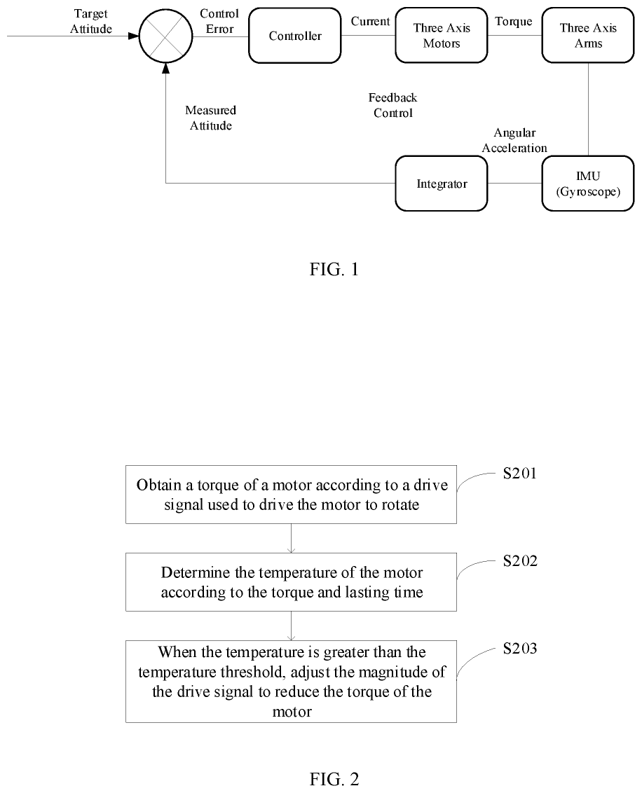

A gimbal consistent with embodiments of the present disclosure may be a handheld gimbal or a gimbal carried by a mobile device (e.g., an unmanned aerial vehicle (UAV), an unmanned vehicle, etc.). The gimbal includes a motor. FIG. 1 is a schematic diagram showing a working principle of a three-axis gimbal according to some embodiments of the present disclosure. FIG. 11 is a schematic structural diagram of a gimbal control device according to some embodiments of the present disclosure. The three-axis gimbal includes a controller 100, three axis motors, three axis arms, an inertial measurement unit (IMU), and an integrator. For the three-axis gimbal, a closed-loop PI (proportion, integration) control system can be formed by using a gyroscope of the IMU as a feedback element and the three axis motors as output elements.

A measured attitude of the gimbal may be obtained by the IMU. A difference between the measured attitude and a target attitude may be used as a control error. The controller 100 may control input currents of the three axis motors according to the control error to drive the three axis motors to operate. The three axis motors may output torques to drive the three axis arms to rotate during the operation. During rotation, the measured attitude of the gimbal may further change to cause the gimbal to move to the target attitude through the above feedback control process.

FIG. 2 is a schematic flowchart of a gimbal control method according to some embodiments of the present disclosure. The method includes the following processes.

At S201, a torque of a motor 300 is obtained according to a drive signal used to drive the motor 300 to rotate.

The torque may be obtained by one of a plurality of manners. For example, in some embodiments, the torque of the motor 300 may be calculated according to a magnitude of the drive signal and a functional relationship between the magnitude of the drive signal of the motor 300 and the motor torque. In some other embodiments, a corresponding correlation table between the drive signal and the motor toque may be pre-stored, and the motor torque corresponding to a current drive signal may be obtained by looking up the table.

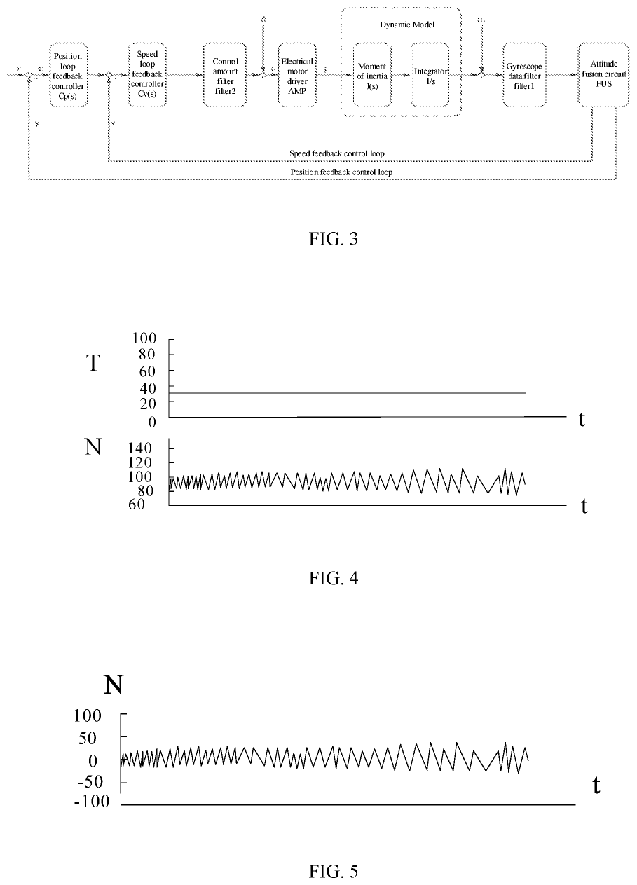

FIG. 3 is a schematic diagram showing a control principle of a gimbal control system according to some embodiments of the present disclosure. FIG. 3 shows a feedback control principle of the gimbal control system. The system from left to right includes a position loop feedback controller Cp(s), a speed loop feedback controller Cv(s), a control amount filter 2, a driver amplifier (AMP) of the motor 300, a kinetic model composed of a moment of inertia J(s) and an integrator 1/s, a gyroscope data filter 1, and an attitude fusion circuit FUS. The system may realize double-loop control according to a signal flow direction and different feedback control objects, that is, the control includes a speed feedback control loop, which is configured to control the gimbal attitude, and a position feedback control loop, which is configured to control the displacement of the gimbal. In FIG. 3, r denotes a reference input signal, e denotes a tracking error signal, a denotes an acceleration signal, v denotes a speed signal, y denotes a displacement signal, d denotes an equivalent disturbance signal, u denotes a control voltage, i denotes a current signal, and nᵥ denotes a measurement noise.

In some embodiments, the torque of the motor 300 may be obtained according to the current of the motor 300. The torque of the motor 300 may refer to a torque output by the motor 300 from a crankshaft end of the motor 300. In the gimbal, the torque may be a force that may cause the axis arm corresponding to the motor 300 to rotate. The current of the motor 300 is proportional to the torque, which is represented by the following formula:

M=Ca×i

where M denotes the torque, Ca denotes a constant, and i denotes the current.

At S202, the temperature of the motor 300 is determined according to the torque and lasting time.

The lasting time may refer to a lasting time, during which the motor 300 outputs the current torque.

In some embodiments, different motors 300 may output different torques with a same inputting drive signal. Temperatures corresponding to the different motors 300 are different according to lasting times of torques of the different motors 300.

When the motor 300 outputs a force that is too large or is in a stalled state, the heat generated may not be effectively dissipated, and hence the temperature of the motor 300 may increase gradually and reach a temperature threshold that could cause the motor 300 to be burned down. In this case, an overheating protection program of the motor 300 needs to be started to prevent the motor 300 from burning down. Therefore, after process S202, the motor 300 may be determined whether the motor 300 outputs the too large force or is in the stalled state according to the temperature of the motor 300. As such, a motor protection function may be started in time after the motor 300 outputs the too large force or in the stalled state to prevent the motor 300 from burning down due to overheating. In some embodiments, after process S202, before determining the temperature to be larger than the temperature threshold, the method further includes determining the torque to be larger than a first torque threshold and determining the lasting time of the torque to be longer than a first time threshold. The first torque threshold may be a torque protection threshold of the motor 300.

As shown in FIG. 4, in a normal working state, the motor 300 outputs the force, and the torque output by the motor 300 is stabilized at a same torque value (as shown in FIG. 4, the torque output by the motor 300 fluctuates around 90 N·m). At this point, the heat of the motor 300 may be dissipated by a heat dissipation system of the motor 300, so that the motor temperature is maintained at a same temperature value (for example, about 30 degrees). Under this temperature, the motor 300 may operate normally. Further, as shown in FIG. 5, in a balanced state, the torque output by the motor 300 fluctuates around 0 N·m.

In an abnormal state, for example, in a state of lasting strong wind, shaking the gimbal manually, etc., the force output by the motor 300 may increase to cause the torque output by the motor 300 to exceed the first torque threshold. If the torque output by the motor 300 only increases for a short period of time, that is, the lasting time of increasing the torque does not reach the first time threshold, the temperature of the motor 300 may not continue to increase to reach the temperature threshold (e.g., 90 degrees) for burning down the motor 300. Thus, the motor 300 may not be burned down. If the lasting time of maintaining the torque output by the motor 300 at the first torque exceeds the first time threshold, the temperature of the motor 300 may continue to increase and cannot be dissipated to reach the temperature threshold for burning down the motor 300. In this case, the overheating protection program of the motor 300 needs to be started to prevent the motor 300 from burning down. For example, in a first case, the motor 300 may output a torque M1 (larger than the first torque threshold) and be stalled, the lasting time may be t1, and the temperature of the motor 300 may reach 90° C. In a second case, the motor 300 may be stalled at M2 (larger than the first torque threshold), the lasting time may be t2, and the temperature of the motor 300 may reach 90° C. If M1>M2, then t1<t2.

In some other examples, after process S202, before determining the temperature to be larger than the temperature threshold, the method further includes determining that the motor 300 is in the stalled state according to the temperature of the motor 300. In the stalled state, for example, the motor 300 may be damaged, the motor 300 may output a maximum force, the temperature of the motor 300 may continue to increase and may not be dissipated to reach the temperature threshold for burning down the motor 300. Therefore, the overheating protection program of the motor 300 may need to be started to prevent the motor 300 from burning down.

In some embodiments, when the motor 300 is stalled, the motor 300 may output the maximum force. That is, the torque of the motor 300 may be the largest when the motor 300 is stalled, and the first torque threshold may be slightly smaller than the torque of the motor 300 when the motor 300 is stalled.

Further, before process S202, the method further includes obtaining a prediction model configured to characterize a mapping relationship between the lasting time of the torque of the motor 300 and the temperature of the motor 300. At process S202, the temperature of the motor 300 may be determined according to the lasting time of the torque and the prediction model. The prediction model may be presented by a mathematical expression manner, a curve manner, or another manner. In some embodiments, the prediction model may be presented by the curve manner. After the lasting time of the torque of the motor is obtained, the temperature of the motor may be determined according to the curve of the prediction model.

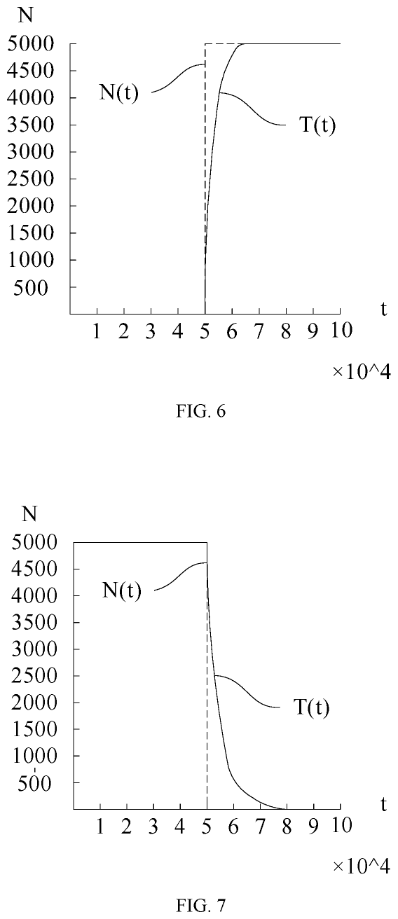

In some embodiments, a curve of a process of the motor temperature increasing with the motor torque needs to be obtained, such that a function of determining whether the motor 300 outputs the too large force or is in the stalled state according to the motor temperature may be realized. In some embodiments, as shown in FIG. 6, obtaining the prediction model configured to characterize the mapping relationship between the lasting time of the motor torque and the motor temperature includes controlling the motor torque to change from zero to the first torque threshold and maintain at the first torque threshold, obtaining then a first relationship model (N(t) shown in FIG. 6) of the motor torque changing with time and a second relationship model (T(t) shown in FIG. 6), and determining the first prediction model according to the first relationship model and the second relationship model. By controlling the magnitude of the drive signal, the motor torque may change from zero to the first torque threshold. In some embodiments, by controlling the magnitude of the drive signal, the motor torque may change from zero to the first torque threshold instantly, that is, the motor torque may be controlled to increase from zero to the first torque threshold in a specific time (smaller than 1 s). As showing in FIG. 6, for the curve N(t), an abscissa represents the time, and an ordinate represents the motor torque. For the curve T(t), an abscissa represents the time, and an ordinate represents a linear mapping of the motor temperature from 0 to 100 degrees to 0 to 5000 N·m.

In some embodiments, in a process of the motor torque changing from zero to the first torque threshold and being maintained at the first torque threshold, the motor temperature may be obtained by a temperature sensor at various time moments. The second relationship model of the motor temperature changing with time may be then determined according to the motor temperature obtained at various time moments. Obtaining the motor temperature at the various time moments may be performed when the temperature sensor is determined in an effective state.

Further, the motor temperature may need to be determined when the motor 300 is in the stalled state. Thus, in practical applications, the motor 300 may be determined whether in the stalled state according to the motor temperature. In some embodiments, the motor temperature increasing with the motor torque includes controlling motor torque to continue to increase from the first torque threshold to cause the motor 300 to be in the stalled state, or controlling the motor torque to increase from zero to cause the motor 300 to be in the stalled state to obtain the motor temperature corresponding to the motor 300 being in the stalled state. Whether the motor 300 is in the stalled state may be determined by using the following manner. In some embodiments, the torque of the motor 300 may be detected by a torque sensor, a rotation speed of the motor 300 may be detected by a speed sensor, and whether the motor 300 is in the stalled state may be determined by the torque and the rotation speed. When the rotation speed of the motor 300 is zero, the motor 300 may output a certain torque, then the motor 300 may be determined to be in the stalled state.

In some embodiments, a curve of the motor temperature decreasing with the motor torque may need to be obtained to reduce the torque of the motor 300 according to the curve of the motor temperature decreasing with the motor torque to realize the overheating protection function of the motor 300. As shown in FIG. 7, obtaining the prediction model configured to characterize the mapping relationship between the lasting time of the motor torque and the motor temperature includes controlling the motor torque to change from the first torque threshold to zero and be maintained at zero, then obtaining a third relationship model of the motor torque changing with time and a fourth relationship model of the motor temperature changing with time, and determining a second prediction model according to the third relationship model and the fourth relationship model. The motor torque changing from the first torque threshold to zero may be realized by controlling the magnitude of the drive signal. In some embodiments, the motor torque may be controlled to change from the first torque threshold to zero instantly by controlling the magnitude of the drive signal. That is, the motor torque may be controlled to reduce from the first torque threshold to zero within a specific time (smaller than 1 second). As shown in FIG. 7, for the curve N(t), the abscissa represents the time, and the ordinate represents the motor torque. For the curve T(t), the abscissa represents the time, and the ordinate represents the linear mapping of the motor temperature from 0 to 100 degrees to 0 to 5000 N·m.

In some embodiments, in a process of the motor torque changing from the first torque threshold to zero and being maintained at zero, the motor temperature may be obtained by the temperature sensor at the various time moments, and then the fourth relationship model of the motor temperature changing with time may be determined according to the obtained motor temperature at the various time moments. Obtaining the motor temperature at the various time moments may be performed by determining that the temperature sensor is in the effective state.

In some embodiments, the temperature sensor may include an analog temperature sensor, such as a thermocouple, or a digital temperature sensor. In some other embodiments, the temperature sensor may be replaced by other temperature measuring elements. Further, most heat may accumulate at a motor coil when the motor 300 is working, to obtain accurate motor temperature, the temperature sensor may be arranged at the motor coil.

At S203, when the temperature is greater than the temperature threshold, the magnitude of the drive signal is adjusted to reduce the torque of the motor 300.

In some embodiments, when the temperature of the motor 300 is greater than the temperature threshold, the overheating protection function of the motor 300 may be started. Explicitly, the magnitude of the drive signal may be adjusted to reduce the torque of the motor 300 to reduce the heat generated by the motor 300 to reduce the temperature of the motor 300. The temperature threshold is a critical value of the temperature for burning down the motor 300. When the temperature of the motor 300 is greater than the temperature threshold, the motor 300 may be burned down.

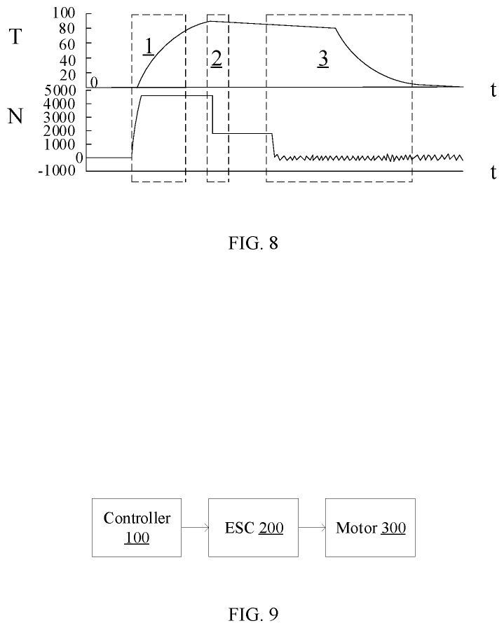

In some embodiments, according to the second prediction model, the magnitude of the drive signal may be adjusted to reduce the torque of the motor 300 to a second torque threshold. The value of the second torque threshold may be selected as needed, and the second torque threshold is smaller than the first torque threshold. In some other embodiments, the first torque threshold may be 5000 N·m, and the second torque threshold may be 2000 N·m. When the drive signal is controlled to cause the torque of the motor 300 to reduce from 5000 N·m to 2000 N·m, the temperature of the motor 300 starts to decrease. As shown in FIG. 8, operational processes of the motor 300 include process 1, process 2, and process 3. During process 1, the motor 300 is in the stalled state. The torque output by the motor 300 changes from 0 N·m to 5000 N·m abruptly, and the temperature of the motor 300 increases. During process 2, the temperature of the motor 300 reaches the temperature threshold of 90 degrees, the overheating protection function of the motor 300 is started to restrict the torque of the motor 300 to reduce to 2000 N·m. During process 3, the motor 300 is not stalled, the temperature of the motor 300 decreases, and the motor 300 outputs the force normally.

In some embodiments, the drive signal may include a control voltage. Adjusting the magnitude of the drive signal may include reducing an amplitude of the control voltage to reduce the torque output by the motor 300 to decrease the temperature of the motor 300.

The manner of reducing the amplitude of the control voltage to decrease may be selected as needed. For example, in some embodiments, the amplitude of the control voltage may be controlled to decrease at a constant speed. That is, the amplitude of the control voltage may be controlled to decrease linearly. In some other embodiments, the amplitude of the control voltage may be controlled to decrease non-linearly.

Consistent with embodiments of the disclosure, the temperature of the motor 300 may be estimated according to a force output condition by the motor 300 (i.e., the motor torque and the lasting time) to obtain the motor temperature more effectively to protect the motor 300. Meanwhile, the cost of the temperature sensor may be saved, and the problem of a temperature protection failure due to improper use of the temperature sensor and lifetime may be avoided.

Corresponding to embodiments of the motor control method of the present disclosure, the present disclosure further provides embodiments of the motor control device.

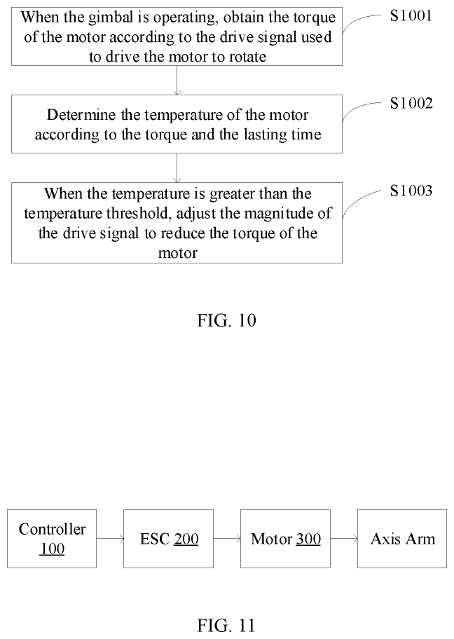

FIG. 9 is a schematic structural block diagram of the motor control device according to some embodiments of the present disclosure. The device includes the controller 100 and an electronic speed control (ESC) 200. The controller 100 is electrically connected to the ESC 200. The ESC 200 is electrically connected to the motor 300.

The motor control device may include one or more controllers 100, which may individually or collectively operate.

The controller may be configured to obtain the torque of the motor 300 according to the drive signal used to drive the motor 300 to rotate, determine the temperature of the motor 300 according to the torque and the lasting time, and, when the temperature is greater than the temperature threshold, adjust the magnitude of the drive signal to reduce the torque of the motor 300.

In some embodiments, after the temperature of the motor 300 is determined, and before the temperature is determined to be greater than the temperature threshold according to the torque and the lasting time, the controller 100 may determine the torque to be greater than the first torque threshold and determine the lasting time of the torque to be greater than the first time threshold or determine the motor 300 to be in the stalled state according to the motor temperature.

In some embodiments, before the temperature of the motor 300 is determined according to the torque and the lasting time, the controller 100 may obtain the prediction model, which is configured to characterize the mapping relationship between the lasting time of the torque of the motor 300 and the temperature of the motor 300.

The controller 100 may be configured to determine the temperature of the motor 300 according to the lasting time of the torque and the prediction model.

In some embodiments, the controller 100 may be configured to control the torque of the motor 300 to change from zero to the first torque threshold and be maintained at the first torque threshold, obtain the first relationship model of the torque of the motor 300 changing with time, obtain the second relationship model of the temperature of the motor 300 changing with time, and determine the first prediction model according to the first relationship model and the second relationship model.

In some embodiments, the controller 100 may be configured to obtain the temperature of the motor 300 at the various time moments through the temperature sensor during the process of changing the torque of the motor 300 from zero to the first torque threshold and maintaining the torque of the motor 300 at the first torque threshold. The controller 100 may be further configured to determine the second relationship model of the temperature of the motor 300 changing with time according to the obtained temperature of the motor 300 at the various time moments.

In some embodiments, the controller 100 may be configured to control the torque of the motor 300 to change from the first torque threshold to zero and be maintained at zero, obtain the third relationship model of the torque of the motor 300 changing with time, obtain the fourth relationship model of the temperature of the motor 300 changing with time, and determine the second prediction model according to the third relationship model and the fourth relationship model.

In some embodiments, the controller 100 may be configured to obtain the temperature of the motor 300 at the various time moments through the temperature sensor during the process of changing the torque of the motor 300 from the first torque threshold to zero and maintaining the torque of the motor 300 at zero. The controller 100 may be further configured to determine the fourth relationship model of the temperature of the motor 300 changing with time according to the temperature of the motor 300 at the various time moments.

In some embodiments, the controller 100 may be configured to adjust the magnitude of the drive signal to reduce the torque of the motor 300 to the second torque threshold according to the second prediction model.

In some embodiments, the drive signal may include a control voltage.

In some embodiments, the controller 100 may be configured to reduce the amplitude of the control voltage.

In some embodiments, the controller 100 may be configured to control the amplitude of the control voltage to decrease at a constant speed.

Consistent with embodiments of the present disclosure, the controller 100 may be configured to estimate the temperature of the motor 300 according to the force output condition of the motor 300 to effectively obtain the temperature of the motor 300. As such, the motor 300 may be protected, the cost of the temperature sensor may be saved, and the problem of the temperature protection failure due to improper use of the temperature sensor and the lifetime.

An example of applying the motor 300 to the gimbal is further described.

As shown in FIG. 10, embodiments of the present disclosure further provide a gimbal control method. The gimbal includes the motor 300. As shown in FIG. 10, the method includes the following processes.

At S1001, when the gimbal is operating, the torque of the motor 300 is obtained according to the drive signal used to drive the motor 300 to rotate.

In some embodiments, according to the drive signal used to drive the motor 300 to rotate, obtaining the torque of the motor 300 may be performed right after the gimbal is powered on to ensure safety of the motor 300.

At S1002, the temperature of the motor 300 is determined according to the torque and the lasting time.

At S1003, when the temperature is greater than the temperature threshold, the magnitude of the drive signal is adjusted to reduce the torque of the motor 300.

The working principle of process S1001 to process S1003 is similar to the working principle of the motor control method of embodiments of the present disclosure, which is not repeated here.

Consistent with embodiments of the present disclosure, the gimbal may estimate the temperature of the motor 300 according to the force output condition of the motor 300 to effectively obtain the temperature of the motor 300. As such, the motor 300 may be protected, the cost of the temperature sensor may be saved, and the problem of the temperature protection failure due to improper use of the temperature sensor and the lifetime.

Corresponding to embodiments of the gimbal control method of the present disclosure, the present disclosure further provides embodiments of the gimbal control device.

FIG. 11 is a schematic structural block diagram of the gimbal control device according to some embodiments of the present disclosure. The device includes the controller 100 and the ESC 200. The controller 100 is electrically connected to the ESC 200. The ESC 200 is electrically connected to the motor 300. The motor 300 is connected to the axis arm. The motor 300 rotates to drive the axis arm to rotate.

The gimbal control device includes one or more controllers 100, which operate individually or collectively.

The controller 100 may be configured to obtain the torque of the motor 300 according to the drive signal used to drive the motor 300 to rotate when the gimbal operates, determine the temperature of the motor 300 according to the torque and the lasting time, and adjust the magnitude of the drive signal to reduce the torque of the motor 300 when the temperature is greater than the temperature threshold.

The working principle of the gimbal control device is similar to the working principle of the motor control device of embodiments of the present disclosure, which is not repeated here.

Consistent with embodiments of the present disclosure, the controller 100 may be configured to estimate the temperature of the motor 300 according to the force output condition of the motor 300 to effectively obtain the temperature of the motor 300. As such, the motor 300 may be protected, the cost of the temperature sensor may be saved, and the problem of the temperature protection failure due to improper use of the temperature sensor and the lifetime.

In addition, embodiments of the present disclosure further provide a computer-readable storage medium, which stores a computer program. When the program is executed by the controller 100, the processes of the motor control method or gimbal control method of embodiments of the present disclosure may be realized.

Those of ordinary skill in the art should understand that all or a part of processes of embodiments of the present disclosure may be completed by the computer program instructing related hardware. The program may be stored in the computer-readable storage medium. When the program is executed, the processes of method embodiments may be realized. The storage medium may include a magnetic disk, an optical disc, a read-only memory (ROM), a random-access memory (RAM), etc.

Only some embodiments of the present disclosure are disclosed above, which should not be used to limit the claim scope of the present disclosure. Equivalent modifications according to the claims of the present invention are still within the scope of the invention.

What is claimed is:

1. A motor control method comprising:
obtaining a torque of a motor according to a drive signal used to drive the motor to rotate;
determining a temperature of the motor according to the torque and a lasting time of the torque; and
in response to determining that the temperature is higher than a temperature threshold, adjusting a magnitude of the drive signal to reduce the torque.

2. The method of claim 1, further comprising, after determining the temperature according to the torque and the lasting time, and before determining that the temperature is higher than the temperature threshold:
determining that the torque is greater than a torque threshold and the lasting time is longer than a time threshold; or
determining that the motor is in a stalled state according to the temperature.

3. The method of claim 1, further comprising, before determining the temperature of the motor according to the torque and the lasting time:
obtaining a prediction model configured to characterize a mapping relationship between the lasting time and the temperature;
wherein determining the temperature according to the torque and the lasting time includes determining the temperature according to the lasting time and the prediction model.

4. The method of claim 3, wherein obtaining the prediction model includes:
controlling the torque to change from zero to a torque threshold and be maintained at the torque threshold;
obtaining a first relationship model of the torque changing with time;
obtaining a second relationship model of the temperature changing with time; and
determining the prediction model according to the first relationship model and the second relationship model.

5. The method of claim 4, wherein obtaining the second relationship model includes:
while the torque changes from zero to the torque threshold and is maintained at the torque threshold, obtaining values of the temperature at various time moments through a temperature sensor; and
determining the second relationship model according to the values of the temperature obtained at the various time moments.

6. The method of claim 3, wherein obtaining the prediction model includes:
controlling the torque to change from a torque threshold to zero and be maintained at zero;
obtaining a first relationship model of the torque changing with time;
obtaining a second relationship model of the temperature changing with time; and
determining the prediction model according to the first relationship model and the second relationship model.

7. The method of claim 6, wherein obtaining the second relationship model includes:
while the torque changes from the torque threshold to zero and is maintained at zero, obtaining values of the temperature at various time moments through a temperature sensor; and
determining the second relationship model according to the values of the temperature obtained at the various time moments.

8. The method of claim 6, wherein:
the torque threshold is a first torque threshold; and
adjusting the magnitude of the drive signal to reduce the torque includes:
adjusting the magnitude of the drive signal to reduce the torque to a second torque threshold according to the prediction model.

9. The method of claim 1, wherein the drive signal includes a control voltage.

10. The method of claim 9, wherein adjusting the magnitude of the drive signal includes:
reducing an amplitude of the control voltage.

11. The method of claim 10, wherein reducing the amplitude of the control voltage includes:
controlling the amplitude of the control voltage to reduce at a constant speed.

12. A motor control device comprising:
an electronic speed control (ESC) connected to a motor; and
one or more controllers connected to the ESC and operating individually or collectively, the one or more controllers being configured to:
obtain a torque of the motor according to a drive signal used to drive the motor to rotate;
determine a temperature of the motor according to the torque and a lasting time of the torque; and
in response to determining that the temperature is higher than a temperature threshold, adjust a magnitude of the drive signal to reduce the torque.

13. The device of claim 12, wherein the one or more controllers are further configured to, after determining the temperature according to the torque and the lasting time and before determining that the temperature is higher than the temperature threshold:
determine that the torque is greater than a torque threshold and the lasting time of the torque is longer than a time threshold; or
determine that the motor is in a stalled state according to the temperature.

14. The device of claim 12, wherein the one or more controllers are configured to, before determining the temperature according to the torque and the lasting time:
obtain a prediction model configured to characterize a mapping relationship between the lasting time and the temperature; and
determine the temperature according to the lasting time and the prediction model.

15. The device of claim 14, wherein the one or more controllers are configured to:
control the torque to change from zero to a torque threshold and be maintained at the torque threshold;
obtain a first relationship model of the torque changing with time;
obtain a second relationship model of the temperature changing with time; and
determine the prediction model according to the first relationship model and the second relationship model.

16. The device of claim 15, wherein the one or more controllers are configured to:
while the torque changes from zero to the torque threshold and is maintained at the torque threshold, obtain values of the temperatures at various time moments through a temperature sensor;
determine a second prediction model according to the values of the temperatures obtained at the various time moments.

17. The device of claim 14, wherein the one or more controllers are configured to:
control the torque to change from a torque threshold to zero and be maintained at zero;
obtain a first relationship model of the torque changing with time;
obtain a second relationship model of the temperature changing with time; and
determine the prediction model according to the first relationship model and the second relationship model.

18. The device of claim 17, wherein the one or more controllers are configured to:
while the torque changes from the first torque threshold to zero and being maintained at zero, obtain values of the temperatures at various time moments through a temperature sensor; and
determine the second relationship model according to the values of the temperatures obtained at the various time moments.

19. The device of claim 17, wherein:
the torque threshold is a first torque threshold; and
the one or more controllers are configured to adjust the magnitude of the drive signal to reduce the torque to a second torque threshold according to the prediction model.

20. A gimbal control method comprising:
while a gimbal is operating, obtaining a torque of a motor of the gimbal according to a drive signal used to drive the motor to rotate;
determining a temperature of the motor according to the torque and a lasting time of the torque; and
in response to determining that the temperature is higher than a temperature threshold, adjusting a magnitude of the drive signal to reduce the torque.
